(19) United States
(12) Patent Application Publication
(10) Pub. No.: US 2016/0019841 A1
(43) Pub. Date: Jan. 21, 2016

(54) DISPLAY PANEL AND ORGANIC LIGHT EMITTING DISPLAY DEVICE HAVING THE SAME

(71) Applicant: SAMSUNG DISPLAY CO., LTD., YONGIN-CITY (KR)

(72) Inventor: MIN-KYU WOO, Cheonan-si (KR)

(21) Appl. No.: 14/585,849

(22) Filed: Dec. 30, 2014

(30) Foreign Application Priority Data
Jul. 21, 2014 (KR) 10-2014-0091617

(51) Int. Cl. G09G 3/32

(52) U.S. Cl. CPC G09G 3/3266; G09G 3/3225; G09G 2310/08; G09G 2320/062; G09G 2330/028; G09G 2330/021

(57) ABSTRACT

A display panel includes a display pixel circuit and a repair pixel circuit. A first node of the display pixel circuit is electrically coupled to an anode of an organic light emitting diode. The repair pixel circuit includes a repair line that is extended in a direction of first through third scan lines. The display pixel circuit is coupled to the first scan line disposed at an (N)th row, and the repair pixel circuit is coupled to the first scan line disposed at an (N−1)th row, where N is an integer greater than or equal to 2.

### CROSS-REFERENCE TO RELATED APPLICATION(S)

This application claims priority under 35 USC §119 to Korean Patent Applications No. 10-2014-0091617, filed on Jul. 21, 2014 in the Korean Intellectual Property Office (KIPO), the disclosure of which is incorporated by reference in its entirety herein.

### BACKGROUND

1. Technical Field

Exemplary embodiments of the inventive concept relate generally to a display panel. More particularly, embodiments of the present inventive concept relate to a display panel and an organic light emitting display device having the same.

2. Discussion of Related Art

Flat panel display (FPD) devices are widely used as a display device of electronic devices because FPD devices are relatively lightweight and thin compared to a cathode-ray tube (CRT) display device. Examples of FPD devices are liquid crystal display (LCD) devices, field emission display (FED) devices, plasma display panel (PDP) devices, and organic light emitting display (OLED) devices. The OLED device has been spotlighted as next-generation display devices because the OLED device has various advantages such as a wide viewing angle, a rapid response speed, a thin thickness, low power consumption, etc.

Generally, the OLED device include a plurality of scan lines, a plurality of data lines, a plurality of pixel circuits coupled to the scan lines and data lines, and a plurality of organic light emitting diodes coupled to the pixel circuits.

As a resolution of the OLED device increases, the number of wires increases and an integration increases. As the number of wires increases and the integration increases, the possibility of defects occurring due to short and open circuits increases. A repair process may be performed on certain pixels to reduce the number of these defects. However, image defects such as a bright spot defect or a dark spot defect may occur on a pixel on which the repair process is performed when a certain image is displayed on a display panel.

### SUMMARY

At least one exemplary embodiment of the inventive concept provides a display panel capable of improving image defects that occur after a repair process.

At least one exemplary embodiment provides an organic light emitting display device having the display panel.

According to an exemplary embodiment of the inventive concept, a display panel includes a first scan line, a second scan line, a third scan line, and an emission control line disposed in one direction (e.g., disposed parallel to each other), a data line and a repair data line disposed across the first through third scan lines, an organic light emitting diode (e.g., disposed at an intersection region of the first through third scan lines and the data line), a display pixel circuit including a first node that is electrically coupled to an anode of the organic light emitting diode, the display pixel circuit being coupled to the first through third scan lines of an (N)th row and the data line, and a repair pixel circuit including a repair line that is extended in a direction (in parallel) of the first through third scan lines, the repair pixel circuit being coupled to the first scan line of an (N−1)th row, the second and third scan lines of the (N)th row, and the repair data line, where N is an integer greater than or equal to 2.

In an exemplary embodiment, the anode of the organic light emitting diode is electrically disconnected from the first node of the display pixel circuit, and a second node is formed by electrically coupling the anode of the organic light emitting diode to the repair line by a repair process when a brightness defect occurs in the organic light emitting diode.

In an exemplary embodiment, the repair pixel circuit includes a driving transistor configured to generate a driving current applied to the organic light emitting diode in response to a data signal applied through the data line, a first switching transistor configured to initialize the second node to have an initialization voltage in response to a first scan signal applied through the first scan line, a second switching transistor configured to initialize a gate electrode of the driving transistor to have the initialization voltage in response to a second scan signal applied through the second scan line, a storage capacitor configured to store the data signal, third and fourth switching transistors configured to form a path through which the data signal is stored in the storage capacitor by turning on in response to a third scan signal applied through the third scan line, and fifth and sixth switching transistors configured to apply the driving current generated by the driving transistor to the second node in response to an emission control signal applied through the emission control line.

In an exemplary embodiment, a gate electrode of the first switching transistor is coupled to the first scan line disposed in the (N−1)th row.

In an exemplary embodiment, the display pixel circuit includes a driving transistor configured to generate a driving current applied to the organic light emitting diode in response to a data signal applied through the data line, a first switching transistor configured to initialize the first node to have an initialization voltage in response to a first scan signal applied through the first scan line, a second switching transistor configured to initialize a gate electrode of the driving transistor to have the initialization voltage in response to a second scan signal applied through the second scan line, a storage capacitor configured to store the data signal, third and fourth switching transistors configured to form a path through which the data signal is stored in the storage capacitor by turning on in response to a third scan signal applied through the third scan line, and fifth and sixth switching transistors configured to apply the driving current generated by the driving transistor to the first node in response to an emission control signal applied through the emission control line.

In an exemplary embodiment, a gate electrode of the first switching transistor is coupled to the first scan line disposed in the (N)th row.

In an exemplary embodiment, the repair data line and the repair pixel circuit are disposed in a non-display area of the display panel.

In an exemplary embodiment, the repair data line and the repair pixel circuit are disposed near one side of the display panel.

In an exemplary embodiment, the repair data line and the repair pixel circuit are disposed near one side of the display panel and a second repair data line and a second repair pixel circuit is disposed near another side of the display panel.

According to an exemplary embodiment of the inventive concept, an organic light emitting display (OLED) device includes a display panel including an organic light emitting diode, a display pixel circuit having a first node coupled to an anode of the organic light emitting diode, and a repair pixel circuit having a repair line, a scan driving unit configured to provide a plurality of scan signals to the display panel through a plurality of scan lines, a data driving unit configured to provide a plurality of data signals to the display panel through a plurality of data lines, an emission control unit configured to provide a plurality of emission control signals to the display panel through a plurality of emission control lines, and a timing control unit configured to control the scan driving unit, the data driving unit, and the emission control unit. The display pixel circuit is coupled to a first scan line disposed at an (N)th row, and the repair pixel circuit is coupled to the first scan line disposed at an (N−1)th row, where N is an integer greater than or equal to 2.

In an exemplary embodiment, an anode of the organic light emitting diode is electrically disconnected from the first node of the display pixel circuit, and a second node is formed by electrically coupling the anode of the organic light emitting diode to the repair line by a repair process when a brightness defect occurs in the organic light emitting diode.

In an exemplary embodiment, the scan signals include a first scan signal applied to the display panel through a first scan line disposed in one direction of the display panel, a second scan signal applied to the display panel through a second scan line disposed in the one direction (e.g., in parallel to the first scan line), and a third scan signal applied to the display panel through a third scan line disposed in the one direction (e.g., in parallel to the first scan line and the second scan line).

In an exemplary embodiment, the repair pixel circuit includes a driving transistor configured to generate a driving current applied to the organic light emitting diode in response to the data signal, a first switching transistor configured to initialize the second node to have an initialization voltage in response to the first scan signal, a second switching transistor configured to initialize a gate electrode of the driving transistor to have the initialization voltage in response to the second scan signal, a storage capacitor configured to store the data signal, third and fourth switching transistors configured to form a path through which the data signal is stored in the storage capacitor by turning on in response to the third scan signal, and fifth and sixth switching transistors configured to apply the driving current generated by the driving transistor to the second node in response to the emission control signal.

In an exemplary embodiment, a gate electrode of the first switching transistor is coupled to the first scan line disposed in the (N−1)th row.

In an exemplary embodiment, the display pixel circuit includes a driving transistor configured to generate a driving current in response to the data signal, a first switching transistor configured to initialize the first node to have an initialization voltage in response to the first scan signal, a second switching transistor configured to initialize a gate electrode of the driving transistor to have the initialization voltage in response to the second scan signal, a storage capacitor configured to store the data signal, third and fourth switching transistors configure to form a path through which the data signal is stored in the storage capacitor by turning on in response to the third scan signal, and fifth and sixth switching transistors configured to apply the driving current generated by the driving transistor to the first node in response to the emission control signal.

In an exemplary embodiment, a gate electrode of the first switching transistor is coupled to the first scan line disposed in the (N)th row.

In an exemplary embodiment, the repair pixel circuit is disposed near one side of the display panel.

In an exemplary embodiment, the repair pixel circuit is disposed near one side of the display panel and a second repair pixel circuit is disposed near another side of the display panel.

According to an exemplary embodiment of the inventive concept, a display panel includes N rows, a data line, and a repair data line. Each row includes: a pixel, a first scan line, a second scan line, a third scan line, an emission control line, and a repair pixel circuit. The pixel includes an OLED and a display pixel circuit. The repair pixel circuit includes a repair line extending in a direction of the first through third scan lines. The repair data line is disposed across the first through third scan lines. The display pixel circuit includes a first node that is electrically coupled to an anode of the organic light emitting diode and the display pixel circuit is coupled to the first through third scan lines of the (N)th row and the data line. The repair pixel circuit is coupled to the first scan line of the (N−1)th row, the second and third scan lines of the (N)th row, and the repair data line. The N is an integer greater than or equal to 2.

Therefore, a display panel and an organic light emitting display device according to at least one exemplary embodiment of the inventive concept may improve image defects by coupling a display pixel circuit and a repair pixel to different scan lines when a repair process of the display panel is performed.

### BRIEF DESCRIPTION OF THE DRAWINGS

Exemplary embodiments of the inventive concept will be more clearly understood from the following detailed description taken in conjunction with the accompanying drawings.

FIG. 1 is a diagram illustrating a display panel according to an exemplary embodiment of the inventive concept.

FIG. 2 is a diagram illustrating an example of disposing lines that are included in the display panel of FIG. 1.

FIG. 3 is a diagram illustrating an example of an image on which a brightness defect occurs on the display panel of FIG. 1.

FIG. 4 is a circuit diagram illustrating a display pixel circuit included in the display panel of FIG. 1 according to an exemplary embodiment of the inventive concept.

FIG. 5 is a circuit diagram illustrating a repair pixel circuit included in the display panel of FIG. 1 according to an exemplary embodiment of the inventive concept.

FIG. 6 is a timing diagram illustrating an operation timing of a display pixel circuit and a repair pixel circuit included in the display panel of FIG. 1.

FIGS. 7 and 8 are drawings illustrating examples of disposing a display pixel circuit and a repair pixel circuit on the display panel of FIG. 1.

FIG. 9 is a block diagram illustrating an organic light emitting display device according to an exemplary embodiment of the inventive concept.

FIG. 10 is a block diagram illustrating an electronic device having the organic light emitting display device of FIG. 9.

FIG. 11 is a diagram illustrating an example in which the electronic device of FIG. 10 is implemented as a smart-phone.

### DETAILED DESCRIPTION

Hereinafter, exemplary embodiments of the present inventive concept will be explained in detail with reference to the accompanying drawings.

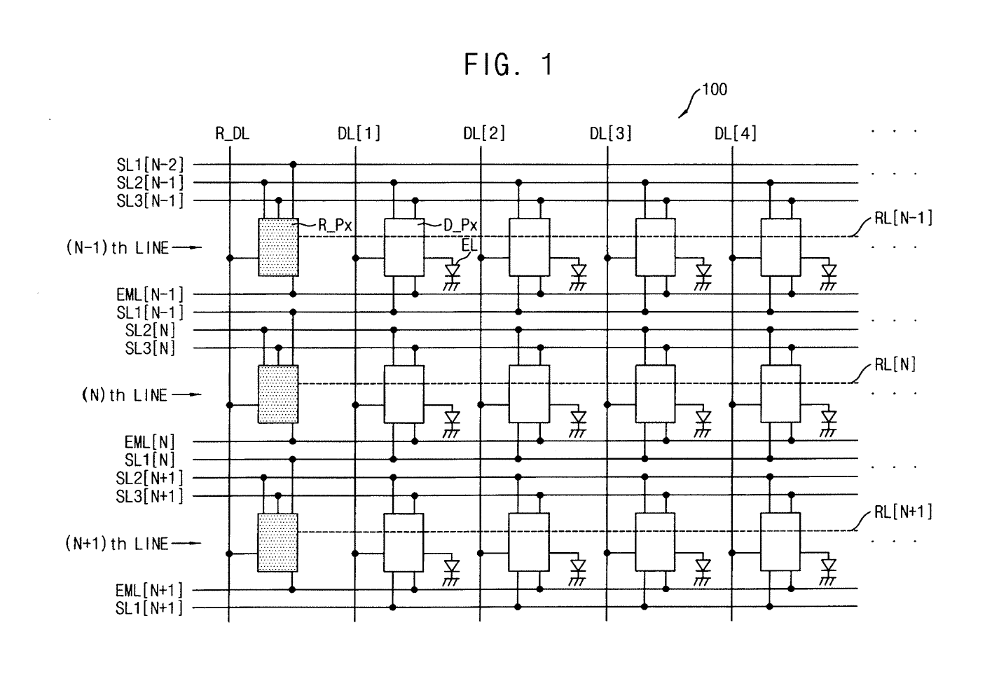

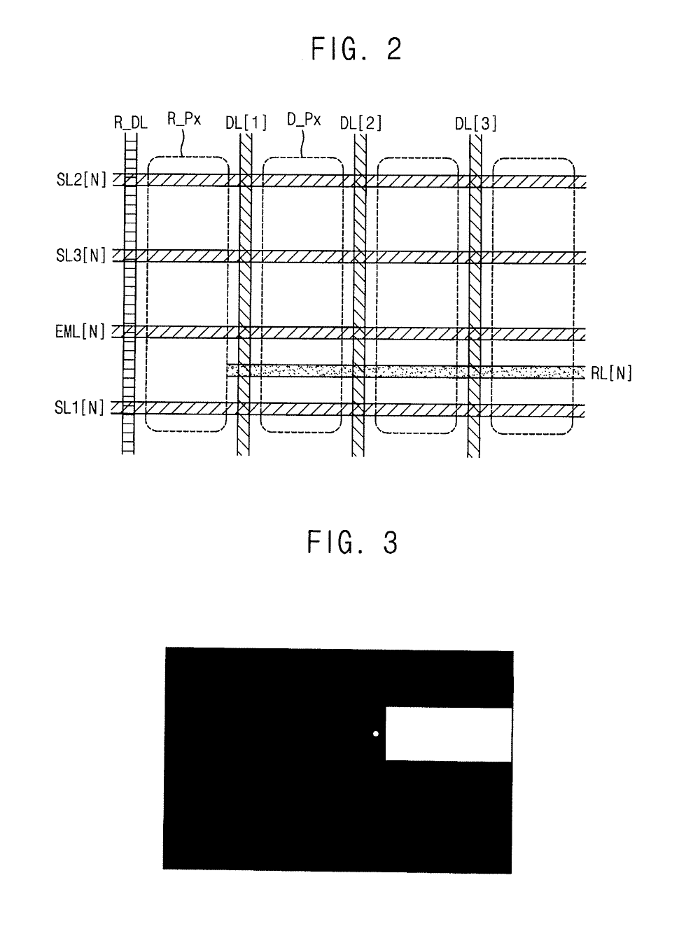

FIG. 1 is a diagram illustrating a display panel according to an exemplary embodiment of the inventive concept, FIG. 2 is a diagram illustrating an example of disposing lines that are included in the display panel of FIG. 1, and FIG. 3 is a diagram illustrating an example of an image on which a brightness defect occurs on the display panel of FIG. 1.

Referring to FIG. 1, a display panel 100 according to an exemplary embodiment includes a first scan line SL1, a second scan line SL2, a third scan line SL3, an emission control line EML, a data line DL, a repair data line RDL, an organic light emitting diode EL, display pixel circuit D_Px, and a repair pixel circuit R_Px.

Generally, the lines included in the display panel may be arranged as illustrated in FIG. 2. Referring to FIG. 2, a first scan line SL1[N], a second scan line SL2[N], an emission control line EML[N], and a third scan line SL3[N] of the (N)th row are disposed in parallel with each other. Further, a repair data line R_DL and data lines DL[1], DL[2], and DL[3] may be disposed across the first scan line SL1[N], the second scan line SL2[N], the emission control line EML[N], and the third scan line SL3[N]. The repair pixel circuit and the display pixel circuit may have the same composition. The repair pixel circuit R_Px may be disposed on an intersection region of the scan lines (specifically, the first scan line SL1[N], the second scan line SL2[N], the emission control line EML[N], and the third scan line SL3[N]) and the repair data line R_DL or under an intersection region of the scan lines (specifically, the first scan line SL1[N], the second scan line SL2[N], the emission control line EML[N], and the third scan line SL3[N]) and the repair data line R_DL. The repair pixel circuit R_Px may include the repair line RL[N] extended in parallel to the first scan line SL1[N], the second scan line SL2[N], the emission control line EML[N], and the third scan line SL3[N]. The display pixel circuit D_Px may be disposed on an intersection region of the scan lines (specifically, the first scan line SL1[N], the second scan line SL2[N], the emission control line EML[N], and the third scan line SL3[N]) and the data lines DL[1], DL[2], and DL[3] or under the intersection region of the scan lines (specifically, the first scan line SL1[N], the second scan line SL2[N], the emission control line EML[N], and the third scan line SL3[N]) and the data lines DL[1], DL[2], and DL[3]. The organic light emitting diode EL may be formed on the display pixel circuit D_Px or under the display pixel circuit D_Px. The display pixel circuit D_Px may include a first node coupled to an anode of the organic light emitting diode EL. When a brightness defect occurs in the organic light emitting diode EL coupled to the display pixel circuit D_Px, the anode of the organic light emitting diode EL is electrically disconnected from the first node of the display pixel circuit D_Px, and a second node is formed by electrically coupling the anode of the organic light emitting diode EL to the repair line RL of the repair pixel circuit R_Px by a repair process. For example, the anode of organic light emitting diode EL on which the brightness defect occurs and the first node of the display pixel circuit D_Px may be cut by irradiating a laser beam, thereby the display pixel circuit D_Px may be electrically separated from the organic light emitting diode EL. For the laser beam, various types of laser beam may be used, for example, an yttrium aluminium garnet (YAG) laser beam having about a several thousand nm wavelength. Then, the anode of the organic light emitting diode EL and the repair line RL of the repair pixel circuit R_Px may be welded by irradiating the laser beam. A parasitic capacitance may form between the repair line RL and the first scan line SL1 adjacent to the repair line RL. Further, the parasitic capacitance may form between the repair line RL and the first node of the display pixel circuit D_Px. When a first scan signal and a voltage of the first node change (e.g. rising or falling), a coupling phenomenon may occur in the anode of the organic light emitting diode EL because of the parasitic capacitance. Thus, a voltage that is applied to the anode of the organic light emitting diode EL may be changed (e.g. risen or fallen) by the coupling phenomenon. Specifically, when a certain image illustrated in FIG. 3 is displayed, a pixel on which the repair process is performed may be brighter than a peripheral area because the voltage of the anode of the organic light emitting diode EL has risen due to the coupling phenomenon. The voltage change of the anode that occurs due to the coupling phenomenon may be prevented by designing the repair pixel circuit R_Px of the display panel of FIG. 1 to be different from the display pixel circuit D_Px. Hereinafter, the display panel of FIG. 1 will be described in detail.

Referring to FIG. 1, the first scan line through third scan lines SL1 through SL3 and the emission control line EML may be disposed in one direction in parallel to each other. A first scan signal may be provided to the display pixel circuit D_Px and the repair pixel circuit R_Px through the first scan line SL1, a second scan signal may be provided to the display pixel circuit D_Px and the repair pixel circuit R_Px through the second scan line SL2, and a third scan signal may be provided to the display pixel circuit D_Px and the repair pixel circuit R_Px through the third scan line SL3. The data line DL and the repair data line R_DL may be disposed across the first through third scan lines SL1, SL2, and SL3. The display panel 100 may include a display area on which an image is displayed on and a non-display area that surrounds the display area. In an exemplary embodiment, the data line DL is disposed in the display area and the repair data line R_DL is displayed in the non-display area. A data signal may be provided to the display pixel circuit D_Px through the data line DL. The data signal may be provided to the repair pixel circuit R_Px through the repair data line R_DL. Here, the repair data line RDL may be electrically coupled to the data line DL that has been coupled to the display pixel circuit D_PX by the repair process using the laser beam. The organic light emitting diode EL may be disposed in an intersection region of the first through third scan lines SL1, SL2, and SL3 and the data line DL. The organic light emitting diode EL includes an anode and a cathode. The anode may be coupled to the display pixel circuit D_Px or the repair pixel circuit R_Px. The anode may receive the driving current from the display pixel circuit D_Px or the repair display pixel circuit R_Px.

The display pixel circuit D_Px may be coupled to the first through third scan lines SL1, SL2, and SL3, the emission control line EML, and the data line DL. The display pixel circuit D_Px may include a first node that is electrically coupled to the anode of the organic light emitting diode EL. The display pixel circuit D_Px may provide the driving current to drive the organic light emitting diode EL. The display pixel circuit D_Px of an (N)th row, where N is an integer greater than or equal to 2, may be coupled to the first scan line of the (N)th row SL1[N], the second scan line of the (N)th row SL2[N], the third scan line of the (N)th row SL3[N], and the emission control line of the (N)th row EML[N].

The repair pixel circuit R_Px may be coupled to the first through third scan lines SL1, SL2, and SL3, the emission control line EML, and the repair data line R_DL. The repair pixel circuit R_Px may include a repair line RL extended in parallel to the first through third scan lines SL1, SL2, and SL3. Here, the repair line RL may be formed floating with the organic light emitting diode EL. When the brightness defect occurs in the organic light emitting diode EL coupled to the display pixel circuit D_Px, the anode of the organic light emitting diode EL is electrically disconnected from the first node of the display pixel circuit D_Px, and the second node is formed by electrically coupling the anode of the organic light emitting diode EL to a repair line R_DL of the repair pixel circuit R_Px by the repair process. The repair pixel circuit R_Px provides the driving current to drive the organic light emitting diode EL to the anode of the organic light emitting diode EL through the second node. The repair pixel circuit R_Px of the (N)th row may be coupled to the first scan line of an (N−1)th row SL1[N−1], the second scan line of the (N)th row SL2[N], the third scan line of the (N)th row SL3[N], and the emission control line of the (N)th row EML[N].

As described, the display panel 100 according to at least one exemplary embodiment may improve the brightness defect that occurs in the repaired organic light emitting diode EL by designing the repair pixel circuit R_Px different from the display pixel circuit D_Px. In an exemplary embodiment, the display pixel circuit D_Px of the (N)th row is coupled to the first scan line of the (N)th row SL1[N] and the repair pixel circuit R_Px of the (N)th row is coupled to the first scan line of the (N−1)th row SL1[N−1]. The coupling phenomenon that occurs due to the parasitic capacitance that is formed between the first scan line SL1 and the repair line and between the first node of the display pixel circuit D_Px and the repair line RL may be offset by respectively coupling the display pixel circuit D_Px of the (N)th row to the first scan line of the (N)th row SL1[N] and the repair pixel circuit R_Px of the (N)th row to the first scan line of the (N−1)th row SL1[N−1]. In an exemplary embodiment, the voltage of the anode of the organic light emitting diode EL does not change because the coupling phenomenon is offset. Thus, the brightness defect that occurs in the repaired organic light emitting diode EL due to the coupling phenomenon may be improved.

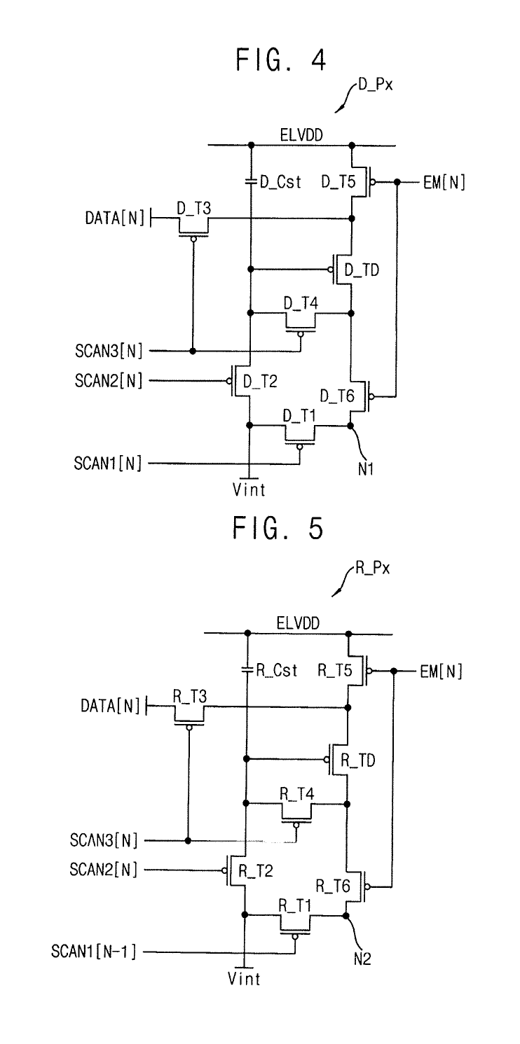

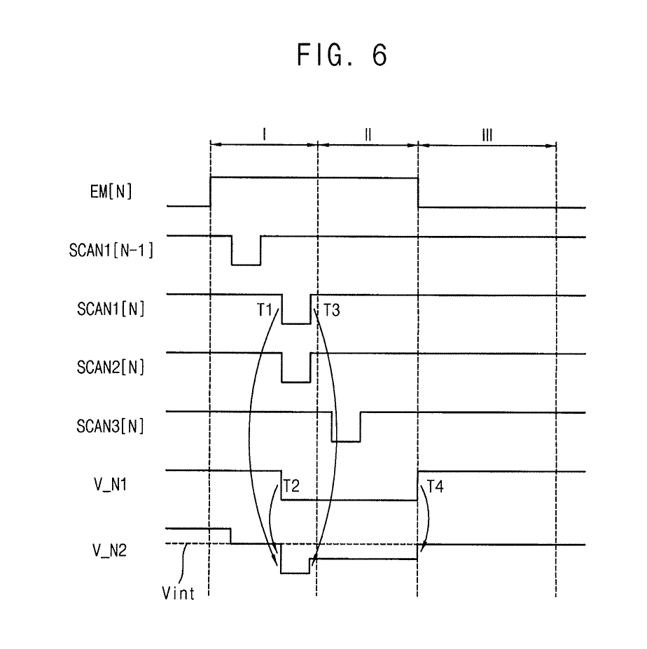

FIG. 4 is a circuit diagram illustrating a display pixel circuit included in the display panel of FIG. 1, FIG. 5 is a circuit diagram illustrating a repair pixel circuit included in the display panel of FIG. 1, and FIG. 6 is a timing diagram illustrating an operation timing of a display pixel circuit and a repair pixel circuit included in the display panel of FIG. 1.

Referring to FIG. 4, the display pixel circuit D_Px includes a driving transistor D_TD, a first switching transistor D_T1, a second switching transistor D_T2, a third switching transistor D_T3, a fourth switching transistor D_T4, a storage capacitor D_Cst, a fifth switching transistor D_T5, and a sixth switching transistor D_T6.

The driving transistor D_TD may generate the driving current that drives the organic light emitting diode in response to the data signal applied through the data line. A first terminal of the driving transistor D_TD is be coupled to the fifth switching transistor D_T5. The first terminal of the driving transistor D_TD may receive a power signal ELVDD according to an operation of the fifth switching transistor D_T5. A gate electrode of the driving transistor D_TD is coupled to the storage capacitor D_Cst. The driving transistor D_TD may generate the driving current according to the data signal that is stored in the storage capacitor D_Cst. A second terminal of the driving transistor D_TD is coupled to the sixth switching transistor D_T6. The second terminal of the driving transistor D_TD may provide the driving current to the first node N1 coupled to the organic light emitting diode according to an operation of the sixth switching transistor D_T6. When the first node N1 is electrically coupled to the organic light emitting diode, the organic light emitting diode may receive the driving current and emit light.

The first switching transistor D_T1 initializes the first node N1 coupled to the anode of the organic light emitting diode to have an initialization voltage Vint in response to the first scan signal SCAN1. A first terminal of the first switching transistor D_T1 is coupled to an initialization voltage line and a second terminal of the first switching transistor D_T1 is coupled to the first node N1. A gate electrode of the first switching transistor D_T1 is coupled to the first scan line. The gate electrode of the first switching transistor D_T1 receives the first scan signal SCAN1. Here, the gate electrode of the first switching transistor D_T1 in the (N)th row may be coupled to the first scan line of the (N)th row. When the first scan signal of the (N)th row SCAN1[N] is applied, the first switching transistor D_T1 is turned on and the initialization voltage Vint is applied to the first node N1 through the initialization voltage line coupled to the first terminal of the first switching transistor D_T1. The initialization voltage Vint may be provided from a power control unit of the organic light emitting display device. When the first node N1 is electrically coupled to the organic light emitting diode, the anode of the organic light emitting diode may be initialized to have the initialization voltage Vint.

The second switching transistor D_T2 initializes the gate electrode of the driving transistor D_TD to have the initialization voltage Vint in response to the second scan signal SCAN2. A first terminal of the second switching transistor D_T2 is coupled to the initialization voltage line and a second terminal of the second switching transistor D_T2 is coupled to the gate electrode of the driving transistor D_TD. The gate electrode of the second switching transistor D_T2 is coupled to the second scan line. The gate electrode of the second switching transistor D_T2 receives the second scan signal SCAN2. When the second scan signal SCAN2 is applied, the second switching transistor D_T2 is turned on and the initialization voltage Vint is applied to the gate electrode of the driving transistor D_TD through the initialization voltage line coupled to the first terminal of the second switching transistor D_T2. In an exemplary embodiment, the initialization voltage Vint is be the same as the initialization voltage Vint applied to the first node N1.

The third switching transistor D_T3 and the fourth switching transistor D_T4 are used to store the data signal DATA to the storage capacitor D_Cst in response to the third scan signal SCAN3. A first terminal of the third switching transistor D_T3 is coupled to the data line and a second terminal of the third switching transistor D_T3 is coupled to the first terminal of the driving transistor D_TD. A gate electrode of the third switching transistor D_T3 is coupled to the third scan line. The gate electrode of the third switching transistor D_T3 receives the third scan signal SCAN3. Further, a first terminal of the fourth switching transistor D_T4 is coupled to the storage capacitor D_Cst and a second terminal of the fourth switching transistor D_T4 is coupled to the second terminal of the driving transistor D_TD. The gate electrode of the fourth switching transistor D_T4 is coupled to the third scan line SCAN 3. The gate electrode of the fourth switching transistor D_T4 receives the third scan signal SCAN3. When the third scan signal SCAN3 is applied, the third switching transistor D_T3 and the fourth switching transistor D_T4 are turned on and the data signal DATA is stored to the storage capacitor D_Cst through the third switching transistor D_T3 and the fourth switching transistor D_T4.

The storage capacitor may store the data signal DATA and control an operation of the driving transistor D_TD.

The fifth switching transistor D_T5 and the sixth switching transistor D_T6 may apply the driving current that flows through the driving transistor D_TD to the organic light emitting diode in response to the emission control signal EM. A first terminal of the fifth switching transistor D_T5 is coupled to the power signal ELVDD and a second terminal of the fifth switching transistor D_T5 is coupled to the first terminal of the driving transistor D_TD. A gate electrode of the fifth switching transistor D_T5 is coupled to the emission control line. The gate electrode of the fifth switching transistor D_T5 receives the emission control signal EM. A first terminal of the sixth switching transistor D_T6 is coupled to the second terminal of the driving transistor D_TD and the second terminal of the sixth switching transistor D_T6 is coupled to the first node N1. When the emission control signal is applied, the fifth switching transistor D_T5 and the sixth switching transistor D_T6 are turned on and the driving current that flows through the driving transistor D_TD is applied to the first node N1. When the first node N1 is electrically coupled to the organic light emitting diode, the organic light emitting diode may receive the driving current and emit light.

Referring to FIG. 5, the repair pixel circuit R_Px includes a driving transistor R_TD, a first switching transistor R_T1, a second switching transistor R_T2, a third switching transistor R_T3, a fourth switching transistor R_T4, a storage capacitor R_Cst, a fifth switching transistor R_T5, and a sixth switching transistor R_T6.

The driving transistor R_TD generates the driving current that drives the organic light emitting diode in response to the data signal applied through the data line. A first terminal of the driving transistor R_TD is coupled to the fifth switching transistor R_T5. The first terminal of the driving transistor R_TD receives a power signal ELVDD according to an operation of the fifth switching transistor R_T5. A gate electrode of the driving transistor R_TD is coupled to the storage capacitor D_Cst. The driving transistor R_TD generates the driving current according to the data signal that is stored in the storage capacitor R_Cst. A second terminal of the driving transistor R_TD is coupled to the sixth switching transistor R_T6. The second terminal of the driving transistor R_TD may provide the driving current to the second node N2 coupled to the organic light emitting diode according to the operation of the sixth switching transistor R_T6. When the second node N2 is electrically coupled to the organic light emitting diode by the repair process, the organic light emitting diode receives the driving current and emits light.

The first switching transistor R_T1 initializes the second node N2 coupled to the anode of the organic light emitting diode to have an initialization voltage Vint in response to the first scan signal SCAN1. A first terminal of the first switching transistor R_T1 is coupled to an initialization voltage line and a second terminal of the first switching transistor R_T1 is coupled to the second node N2. A gate electrode of the first switching transistor R_T1 is coupled to the first scan line. The gate electrode of the first switching transistor R_T1 receives the first scan signal SCAN1. Here, the gate electrode of the first switching transistor R_T1 in the (N)th row may be coupled to the first scan line of the (N−1)th row. When the first scan signal of the (N−1)th row SCAN1[N−1] is applied, the first switching transistor R_T1 is turned on and the initialization voltage Vint is applied to the second node N2 through the initialization voltage line coupled to the first terminal of the first switching transistor R_T1. The initialization voltage Vint may be provided from a power control unit of the organic light emitting display device. When the second node N2 is electrically coupled to the organic light emitting diode by the repair process, the anode of the organic light emitting diode is initialized with the initialization voltage Vint.

The second switching transistor R_T2 initializes the gate electrode of the driving transistor R_TD to have the initialization voltage Vint in response to the second scan signal SCAN2. A first terminal of the second switching transistor R_T2 is coupled to the initialization voltage line and a second terminal of the second switching transistor R_T2 is coupled to the gate electrode of the driving transistor R_TD. The gate electrode of the second switching transistor R_T2 is coupled to the second scan line. The gate electrode of the second switching transistor R_T2 receives the second scan signal SCAN2. When the second scan signal SCAN2 is applied, the second switching transistor R_T2 is turned on and the initialization voltage Vint is applied to the gate electrode of the driving transistor R_TD through the initialization voltage line coupled to the first terminal of the second switching transistor R_T2. In an exemplary embodiment, the initialization voltage Vint is the same as the initialization voltage Vint applied to the second node N2.

The third switching transistor R_T3 and the fourth switching transistor R_T4 store the data signal DATA to the storage capacitor R_Cst in response to the third scan signal SCAN3. A first terminal of the third switching transistor R_T3 is coupled to the data line and a second terminal of the third switching transistor R_T3 is coupled to the first terminal of the driving transistor R_TD. A gate electrode of the third switching transistor R_T3 is coupled to the third scan line. The gate electrode of the third switching transistor R_T3 receives the third scan signal SCAN3. Further, a first terminal of the fourth switching transistor R_T4 is coupled to the storage capacitor R_Cst and a second terminal of the fourth switching transistor R_T4 is coupled to the second terminal of the driving transistor R_TD. The gate electrode of the fourth switching transistor R_T4 is coupled to the third scan line SCAN 3. The gate electrode of the fourth switching transistor R_T4 receives the third scan signal SCAN3. When the third scan signal SCAN3 is applied, the third switching transistor R_T3 and the fourth switching transistor R_T4 are turned on and the data signal DATA is stored to the storage capacitor R_Cst through the third switching transistor R_T3 and the fourth switching transistor R_T4.

The storage capacitor may store the data signal DATA and control an operation of the driving transistor R_TD.

The fifth switching transistor R_T5 and the sixth switching transistor R_T6 may apply the driving current that flows through the driving transistor R_TD to the organic light emitting diode in response to the emission control signal EM. A first terminal of the fifth switching transistor R_T5 is coupled to the power signal ELVDD and a second terminal of the fifth switching transistor R_T5 is coupled to the first terminal of the driving transistor R_TD. In an exemplary embodiment, the power signal ELVDD has a voltage greater than a ground voltage. A gate electrode of the fifth switching transistor R_T5 is coupled to the emission control line. The gate electrode of the fifth switching transistor R_T5 receives the emission control signal EM. A first terminal of the sixth switching transistor R_T6 is coupled to the second terminal of the driving transistor R_TD and the second terminal of the sixth switching transistor R_T6 is coupled to the second node N2. When the emission control signal is applied, the fifth switching transistor R_T5 and the sixth switching transistor R_T6 are turned on and the driving current that flows through the driving transistor R_TD is applied to the second node N2. When the second node N2 is electrically coupled to the organic light emitting diode by the repair process, the organic light emitting may received the driving current and emit light.

Referring to FIGS. 4 through 6, the display pixel circuit and the repair pixel circuit are operated in an initialization period I, a scan period II, and an emission period III. When the organic light emitting diode EL is electrically disconnected from the display pixel circuit D_Px, and the organic light emitting diode EL is electrically coupled to the repair pixel circuit R_Px by the repair process, the repair pixel circuit R_Px is operated different from the display pixel circuit D_Px. Here, the voltage V_N2 of the second node N2 of the repair pixel circuit R_Px disposed in the (N)th row is changed in synchronization with the first scan signal of the (N)th row SCAN1[N] and the voltage V_N1 of the first node N1 of the display pixel circuit D_Px because of the coupling phenomenon.

During the initialization period I, the first scan signal SCAN1 and the second signal SCAN2 are applied. Here, the first scan signal of the (N)th row SCAN1[N] is applied to the display pixel circuit D_Px disposed in the (N)th row and the first scan signal of the (N−1)th row SCAN1[N−1] is applied to the repair pixel circuit R_Px disposed in the (N)th row. When the first scan signal of the (N−1)th row SCAN1[N−1] is applied to the repair pixel circuit R_Px, the first transistor R_T1 of the repair pixel circuit R_Px is turned on and the second node N2 is initialized to have the initialization voltage Vint. For example, during the initialization period I when the first scan signal of the (N−1)th row is low, the first transistor R_T1 is turned on. Further, when the first scan signal of the (N)th row SCAN1[N] is applied to the display pixel circuit D_Px, the first transistor D_T1 of the display pixel circuit D_Px is turned on and the first node N1 is initialized to have the initialization voltage Vint. For example, during the initialization period I when the first scan signal of the (N)th row is low, the first transistor D_T1 is turned on. Here, the voltage V_N2 of the second node N2 may be changed by the parasitic capacitance formed between the first scan line of the (N)th row and the repair line and the parasitic capacitance formed between the first node N1 and the repair line. The voltage V_N2 of the second node N2 may be applied to the anode of the organic light emitting diode EL because the second node N2 is coupled to the anode of the organic light emitting diode EL. Thus, the brightness of the organic light emitting diode EL may be changed according to the voltage of the second node V_N2. Specifically, the voltage V_N2 of second node N2 may fall at a first timing T1 and a second timing T2 because of the coupling phenomenon. When the first scan signal of the (N)th row SCAN1[N] falls (i.e., at the first timing T1), the voltage V_N2 of the second node N2 may fall because of the coupling phenomenon that occurs due to the parasitic capacitance formed between the first scan line of the (N)th row and the repair line. Further, when the voltage V_N1 of the first node N1 is changed to have the initialization voltage Vint (i.e., at the second timing T2), the voltage V_N2 of the second node N2 may fall because of the coupling phenomenon that occurs by the parasitic capacitance formed between the first node N1 and the repair line. Thus, during the initialization period I, the voltage V_N2 of the second node N2 may drop down below the initialization voltage Vint because of the coupling phenomenon. The voltage V_N2 of the second node N2 may rise at a third timing T3 because of the coupling phenomenon. When the first scan signal of the (N)th row SCAN1[N] rises (i.e., at the third timing T3), the voltage V_N2 of the second node N2 may rise because of the coupling phenomenon that occurs by the parasitic capacitance formed between the first scan line of the (N)th row and the repair line. Further, during the initialization period I, the second scan signal of the (N)th row SCAN2[N] is applied to the display pixel circuit D_Px and the repair pixel circuit R_Px. When the second scan signal of the (N)th row SCAN2[N] is applied, each of the second switching transistors D_T2 and R_T2 are turned on and each of the gate electrodes of the driving transistors D_TD and R_TD are initialized to have the initialization voltage Vint. For example, when the second scan signal of the (N)th row during the initialization period I is low, the second switching transistors D_T2 and R_T2 are turned on.

During the scan period II, the third scan signal of the (N)th row SCAN3[N] is applied to the display pixel circuit D_Px and the repair pixel circuit R_Px. When the third scan signal of the (N)th row SCAN3[N] is applied, each of the third switching transistors D_T3 and R_T3 of the display pixel circuit D_Px and the repair pixel circuit R_Px are turned on and each of the fourth switching transistors D_T4 and R_T4 of the display pixel circuit D_Px and the repair pixel circuit R_Px are turned on. For example, when the third scan signal of the (N)th row during the scan period II is low, the third switching transistors D_T3 and R_T3 and the fourth switching transistors D_T4 and R_T4 are turned on. Then, the data signal DATA is stored to the storage capacitor D_Cst through the path formed by the third switching transistor D_T3 and the fourth switching transistor D_T4 of the display pixel circuit D_Px. Further, the data signal DATA is stored to the storage capacitor R_Cst through the path formed by the third switching transistor R_T3 and the fourth switching transistor R_T4 of the repair pixel circuit R_Px.

During the emission period III, the emission control signal of the (N)th row EM[N] is applied to the display pixel circuit D_Px and the repair pixel circuit R_Px. When the emission control signal of the (N)th row EM[N] is applied, the fifth switching transistor D_T5 and the sixth switching transistor D_T6 of the display pixel circuit D_Px are turned on and the driving current is provided to the first node N1. For example, when the emission control signal of the (N)th row during the emission period III is low, the fifth and sixth switching transistors D_T5 and D_T6 of the display pixel circuit D_Px are turned on. The voltage V_N1 of the first node N1 of the display pixel circuit D_Px may rise from the initialization voltage Vint to an operation voltage of the organic light emitting diode EL. Further, when the emission control signal of the (N)th row EM[N] is applied, the fifth switching transistor R_T5 and the sixth switching transistor R_T6 of the repair pixel circuit R_Px are turned on and the organic light emitting diode EL may emit light. For example, when the emission control signal of the (N)th row during the emission period III is low, the fifth and sixth switching transistors R_T5 and R_T6 of the repair pixel circuit R_Px are turned on. The voltage V_N2 of the second node N2 may rise to the operation voltage of the organic light emitting diode. Here, the voltage V_N2 of the second node N2 may rise at a fourth timing T4 because of the coupling phenomenon. When the voltage V_N1 of the first node N1 rises to the operation voltage of the organic light emitting diode (i.e., at the fourth timing T4), the voltage V_N2 of the second node N2 may rise over the operation voltage of the organic light emitting diode because of the coupling phenomenon that occurs by the parasitic capacitance formed between the first node N1 and the repair line. Thus, the voltage V_N2 of the second node N2 that has fallen at the first timing T1 and the second timing T2 may be offset with the voltage V_N2 of the second node N2 that has risen at the third timing T3 and the fourth timing T4.

As described, when the organic light emitting diode EL is electrically disconnected from the display pixel circuit D_Px, and the organic light emitting diode EL is electrically coupled to the repair pixel circuit R_Px by the repair process, the voltage change of the anode of the organic light emitting diode EL that occurs due to the parasitic capacitance may be prevented by applying the first scan signal to the display pixel circuit D_Px and the repair pixel circuit R_Px at a different timing. Specifically, during the initialization period I, the second node N2 of the repair pixel circuit R_Px is initialized to have the initialization voltage by the first scan signal of the (N−1)th row SCAN1[N−1]. When the first scan signal of the (N)th row SCAN1[N] falls (i.e., at the first timing T1), the voltage V_N2 of the second node N2 may fall because of the parasitic capacitance formed between the first scan line of the (N)th row and the repair line. Further, when the voltage V_N1 of the first node N1 of the display pixel circuit D_Px falls (i.e., at the second timing T2), the voltage V_N2 of the second node N2 may fall because of the parasitic capacitance formed between the first node N1 and the repair line. When the first scan signal of the (N)th row SCAN1[N] rises (i.e., at the third timing T3), the voltage V_N2 of the second node N2 may rise because of the parasitic capacitance formed between the first scan line of the (N)th row and the repair line. During the emission period III, when the voltage V_N1 of the first node N1 of the display pixel circuit D_Px rises to the operation voltage of the organic light emitting diode EL, the voltage V_N2 of the second node N2 may rise because of the parasitic capacitance formed between the first node N1 and the repair line. Thus, the voltage V_N2 of the second node N2 that has fallen at the first timing T1 and the second timing T2 may be offset with the voltage V_N2 of the second node N2 that has risen at the third timing T3 and the fourth timing T4.

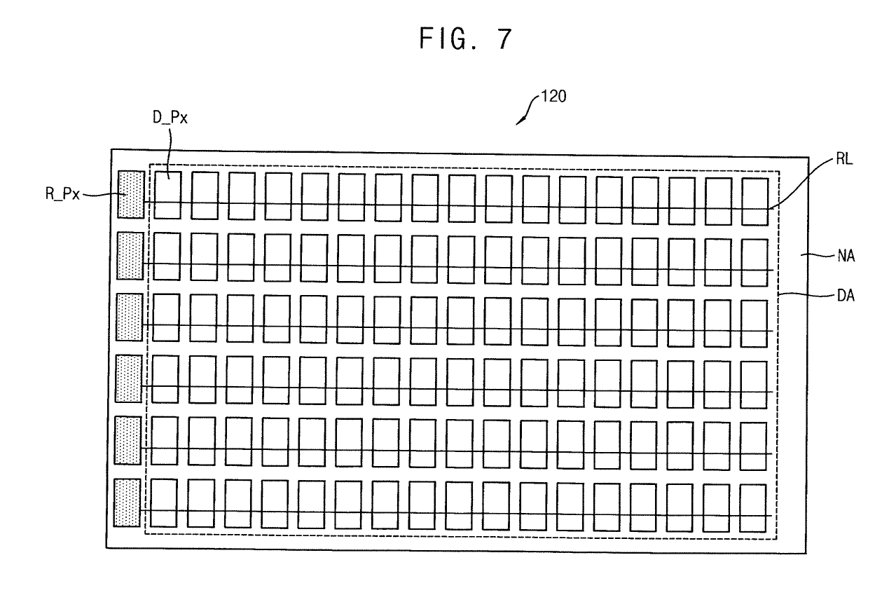

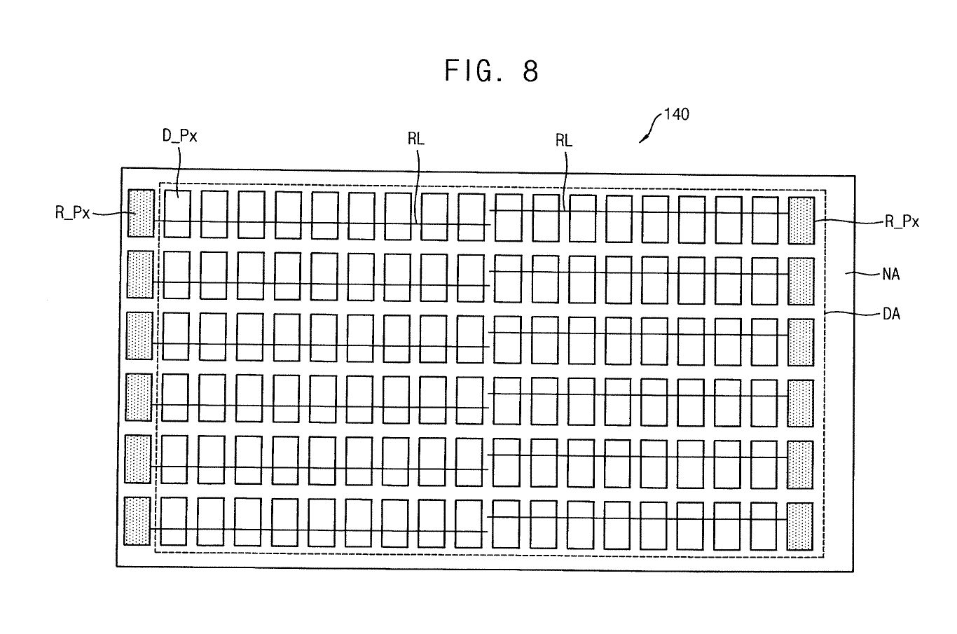

FIGS. 7 and 8 are drawings illustrating examples of disposing a display pixel circuit and a repair pixel circuit on the display panel of FIG. 1.

The display panel includes a display area DA and a non-display area NA. The display area DA is an area that displays an image and the non-display area NA is an area that surrounds the display area DA. Referring to the display panel 100 of FIG. 1, the display pixel circuits D_Px are disposed within the display area DA and the repair pixel circuits R_Px are disposed outside the display area DA in the non-display area NA. Referring to FIG. 7, repair pixel circuits R_Px are disposed near one side of the display panel 120. For example, a column of repair pixel circuits R_Px may be present, where each repair pixel circuit R_Px in the column corresponds to a different row of pixels in the display area DA. The repair data line R_DL may be disposed near one side of the non-display area NA on which the repair pixel circuit R_Px is disposed. The repair line RL may be coupled to the repair pixel circuit R_Px and be extended to an end of the display area DA. For example, a repair line RL may be connected to a repair pixel circuit R_Px located in the non-display area NA, extend into a left side of the display area DA to overlap with all pixels of a row and end at or near the right side of the display area DA. Referring to FIG. 8, repair pixel circuits R_Px are disposed near both sides of the display panel 140. For example, a first column of the repair pixel circuits R_Px is disposed in the non-display area NA at one end of the display panel 140 and a second column of the repair pixel circuits R_Px is disposed in the display area at the other end of the display panel 140. The repair data line R_DL may be disposed near both sides of the non-display area NA on which the repair pixel circuit R_Px is disposed. For example, a first repair data line may be disposed along the first column within the non-display area NA and a second repair data line may be disposed on the second column within the display area DA. A repair line RL may be coupled to a repair pixel circuit R_Px and be extended to the display area DA. A repair line RL may be extended to a center of the display area DA. In an exemplary embodiment, the display area DA is divided into a first area and a second area, where a first group of repair lines RL are located within the first area and a second group of repair lines RL are located within the second area. For example, as shown in FIG. 8, the repair lines RL of the first group connect to the repair pixel circuits R_Px in the first column and then extend through the first area to the center, and the repair group lines RL of the second group connect to the repair pixel circuits R_Px in the second column and then extend through the second area to the center. As shown in FIG. 8, the repair lines of the first group need not align with the repair lines of the second group.

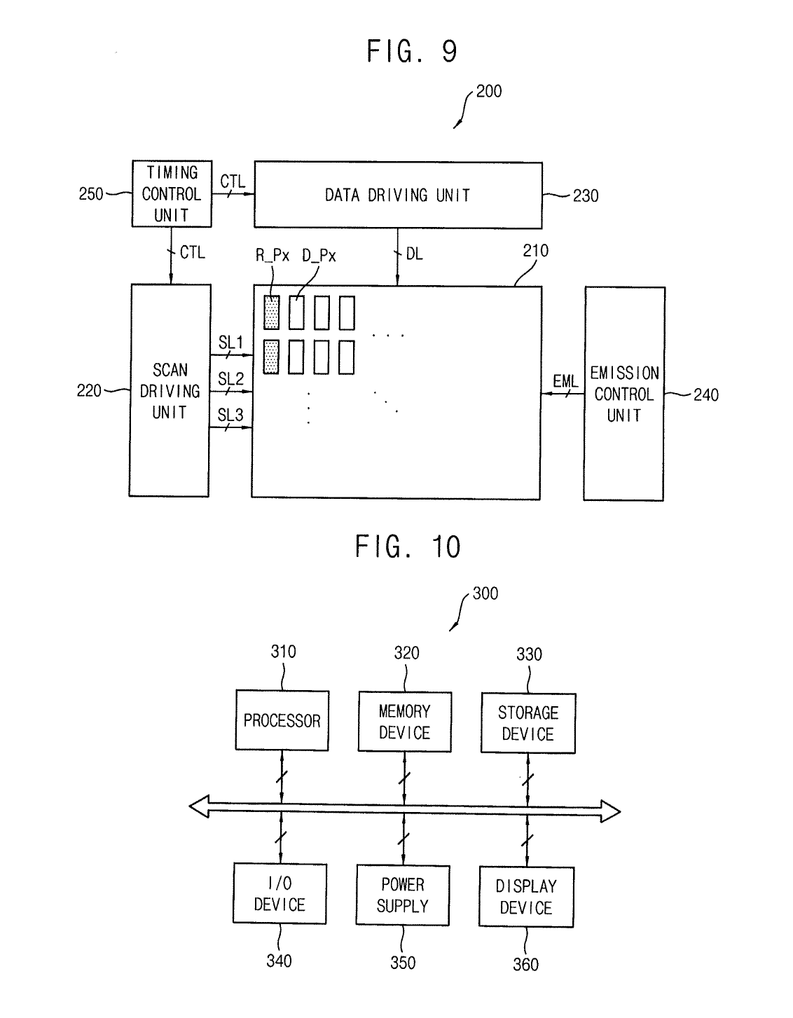

FIG. 9 is a block diagram illustrating an organic light emitting display device according to an exemplary embodiment of the inventive concept.

Referring to FIG. 9, an organic light emitting display device 200 includes a display panel 210, a scan driving unit 220, a data driving unit 230, and an emission control unit 240, and a timing control unit 250. The display panel 210 may correspond to the display panel 100 of FIG. 1.

The display panel 210 may include a display area and a non-display area. An organic light emitting diode and a display pixel circuit that is electrically coupled to the organic light emitting diode are disposed in the display area. A repair pixel circuit may be present having a repair line that is extended to the display area floating with the organic light emitting diode in the non-display area. A plurality of scan signals may be applied to the display pixel circuit and the repair pixel circuit. The scan signal that is applied to the repair pixel circuit may be different from the scan signal that is applied to the display pixel circuit. Specifically, the display panel 210 may include a first scan line, a second scan line, a third scan line, an emission control line, a data line, a repair data line, an organic light emitting diode, a display pixel circuit, and a repair pixel circuit. The organic light emitting diode and the display pixel circuit may be disposed on an intersection region of the first through third scan lines and the data line. The display pixel circuit may include a first node that is electrically coupled to the organic light emitting diode. The repair pixel circuit may be disposed on the intersection region of the first through third scan lines and the repair data line. When a brightness defect occurs in the organic light emitting diode, an anode of the organic light emitting diode may be electrically disconnected from the first node of the display pixel circuit, and a second node may be formed by electrically coupling the anode of the organic light emitting to the repair line of the repair pixel circuit by a repair process. A parasitic capacitance may be formed between the repair line and the first scan line adjacent to the repair line. Further, the parasitic capacitance may be formed between the repair line and the first node of the display pixel circuit. A coupling phenomenon may occur at the anode of the organic light emitting diode by the parasitic capacitance. The pixel on which a repair process is performed may be brighter or darker than other pixels due to the coupling phenomenon. The repair pixel circuit may be designed different from the display pixel circuit. In an exemplary embodiment, the coupling phenomenon that occurs in the anode of the organic light emitting diode is offset by coupling the display pixel circuit disposed in an (N)th row to the first scan line of the (N)th row and coupling the repair pixel circuit disposed in the (N)th row to the first scan line of the (N−1)th row. The voltage of the second node of the repair pixel may change in synchronization with the first scan signal of the (N)th row and a voltage of the first node. During the initialization period, the voltage of the second node of the repair pixel circuit may be initialized to have the initialization voltage by the first scan signal of the (N−1)th row. When the first scan signal of the (N)th row falls, the voltage of the second node of the repair pixel may fall below the initialization voltage because of the parasitic capacitance formed between the first scan line of the (N)th row and the repair line. Further, when the voltage of the first node falls, the voltage of the second node of the repair pixel circuit may further fall because of the parasitic capacitance formed between the first node and the repair line. After then, when the first scan signal of the (N)th row rises, the voltage of the second node of the repair pixel may rise because of the parasitic capacitance formed between the first scan line of the (N)th row and the repair line. During the emission period, the voltage of the second node of the repair pixel may rise. When the voltage of the first node of the display pixel circuit rises, the voltage of the second node may rise because of the parasitic capacitance formed between the first node and the repair line. As described, the voltage change of the anode of the organic light emitting diode that occurs due to the parasitic capacitance may be prevented by respectively applying the first scan signal to the display pixel circuit and the repair pixel circuit at a different timing. Since a composition and an operation of the display pixel circuit and the repair pixel circuit are described in FIGS. 4 through 6, a detailed description of the composition and the operation of the display pixel circuit and the repair pixel circuit is omitted.

The scan driving unit 220 may provide the plurality of scan signals to the display panel 210 through a plurality of scan lines. In an exemplary embodiment, the scan driving unit 220 provides the first scan signal to the display panel 210 through the first scan line SL1, provides the second scan signal to the display panel 210 through the second scan line SL2 disposed in parallel to the first scan line SL1, and provides the third scan signal to the display panel 210 through the third scan line SL3 disposed in parallel to the first scan line SL1 and the second scan line SL2.

The data driving unit 230 provides a data signal to the display panel 210 through a plurality of data lines. The data lines may be disposed across the first through third scan lines. Further, a repair data line may be disposed in parallel to the data lines in the non-display area of the display panel 210. The repair data line may provide the data signal to the repair pixel circuit by electrically coupling to the data line of which the repair process is performed.

The emission control unit 240 provides the emission control signal to the display panel 210 through a plurality of emission control lines. The emission control lines may be disposed in parallel to the first through third scan lines. While the organic light emitting display device 200 that includes the emission control unit 240 is illustrated in FIG. 9, the composition of the organic light emitting display device 200 is not limited thereto. For example, in an exemplary embodiment, the organic light emitting device 200 does not include the emission control unit 240 and the emission control signal is provided from the scan driving unit 220.

The timing control unit 250 may control the scan driving unit 220, the data driving unit 230, and the emission control unit 240 by generating a plurality of control signals. Although a power control unit is not illustrated in FIG. 9, the display panel 210 may receive power signals ELVDD and ELVSS and the initialization voltage signal from the power control unit. In an exemplary embodiment, the power signal ELVSS is a ground voltage.

As described, when the brightness defect occurs, the repair process may be performed. In at least one exemplary embodiment, the anode of the organic light emitting diode is electrically disconnected from the first node of the display pixel circuit and the second node of the repair pixel circuit is electrically connected to the organic light emitting diode by electrically coupling the anode of the organic light emitting diode to the repair line of the repair pixel circuit. In an exemplary embodiment, the display pixel circuit and the repair pixel circuit are designed different from each other to prevent a voltage change of the anode that occurs due to the parasitic capacitance between the first scan line and the repair line and the parasitic capacitance between the first node and the repair line. The voltage change of the anode that occurs due to the coupling phenomenon may be prevented by coupling the display pixel circuit of the (N)th row to the first scan line of the (N)th row and by coupling the repair pixel circuit of the (N)th row to the first scan line of the (N−1)th row.

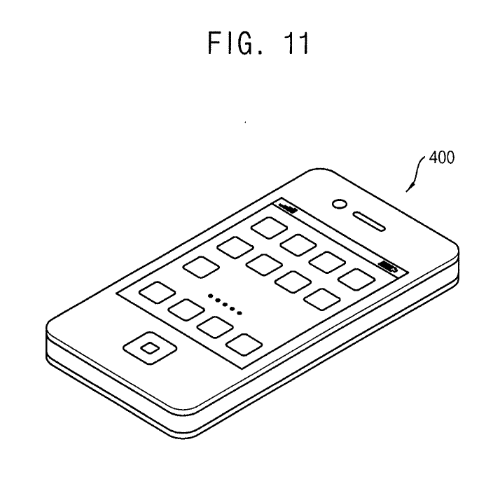

FIG. 10 is a block diagram illustrating an electronic device having the organic light emitting display device of FIG. 9 and FIG. 11 is a diagram illustrating an example in which the electronic device of FIG. 10 is implemented as a smart-phone.

Referring to FIGS. 10 and 11, the electronic device includes a processor 310, a memory device 320, a storage device 330, an input/output (I/O) device 340, a power supply 350 and a display device 360. Here, the display device 360 may correspond to the display device 200 of FIG. 9. In addition, the electronic device 300 may further include a plurality of ports for communicating with a video card, a sound card, a memory card, a universal serial bus (USB) device, other electronic devices, etc. Although it is illustrated in FIG. 11 that the electronic device 300 is implemented as a smart-phone 400, the type of the electronic device 300 is not limited thereto.

The processor 310 may perform various computing functions. The processor 310 may be a micro processor, a central processing unit (CPU), etc. The processor 310 may be coupled to other components via an address bus, a control bus, a data bus, etc. Further, the processor 310 may be coupled to an extended bus such as a peripheral component interconnect (PCI) bus. The memory device 320 may store data for operations of the electronic device 300. For example, the memory device 320 may include at least one non-volatile memory device such as an erasable programmable read-only memory (EPROM) device, an electrically erasable programmable read-only memory (EEPROM) device, a flash memory device, a phase change random access memory (PRAM) device, a resistance random access memory (RRAM) device, a nano floating gate memory (NFGM) device, a polymer random access memory (PoRAM) device, a magnetic random access memory (MRAM) device, a ferroelectric random access memory (FRAM) device, etc, and/or at least one volatile memory device such as a dynamic random access memory (DRAM) device, a static random access memory (SRAM) device, a mobile DRAM device, etc. The storage device 330 may be a solid state drive (SSD) device, a hard disk drive (HDD) device, a CD-ROM device, etc.

The I/O device 340 may be an input device such as a keyboard, a keypad, a touchpad, a touch-screen, a mouse, etc, and an output device such as a printer, a speaker, etc. In an exemplary embodiment, the display device 360 is included in the I/O device 340. The power supply 350 may provide a power for operations of the electronic device 300. The display device 360 may communicate with other components via the buses or other communication links. As described, the display device 360 may include a display panel having a display pixel circuit and a repair pixel circuit. The display panel may include a first scan line, a second scan line, a third scan line, an emission control line, a data line, a repair data line, an organic light emitting diode, the display pixel circuit, and the repair pixel circuit. The organic light emitting diode, the display pixel circuit may be disposed on an intersection region of the scan lines and the data line in a display area. In an exemplary embodiment, the repair pixel circuit is disposed on an intersection region of the scan lines and the repair data line is disposed in a non-display area. The repair pixel circuit may be coupled to the first through third scan line, the emission control line, and the repair data line. The repair pixel circuit may include a repair line extended in parallel to the first through third scan lines. When a brightness defect occurs in the organic light emitting diode, an anode of the organic light emitting diode is electrically disconnected from a first node of the display pixel circuit and a second node is formed by electrically coupling the anode of the organic light emitting diode to the repair line of the repair pixel circuit. The display pixel circuit and the repair pixel circuit may be designed different from each other to prevent a voltage change of the anode from occurring due to a parasitic capacitance formed between the first scan line and the repair line and a parasitic capacitance formed between the first node and repair line. In an exemplary embodiment, the display pixel circuit of the (N)th row is electrically coupled to the first scan line of the (N)th row and the repair pixel circuit of the (N)th row is electrically coupled to the first scan line of the (N−1)th row. During the initialization period the voltage of the anode of the organic light emitting diode may fall because of the coupling phenomenon that occurs due to a falling signal of the first scan signal of the (N)th row and a falling voltage of the first node. Further, during the initialization period, the voltage of the anode of the organic light emitting diode may rise because of the coupling phenomenon that occurs due to a rising signal of the first scan signal of the (N)th row. During the emission period, the voltage of the anode of the organic light emitting diode may rise because of the coupling phenomenon that occurs due to a rising voltage of the first node. As described, the voltage of the anode does not change because the coupling phenomenon that occurs in the anode of the organic light emitting diode is offset.

An exemplary embodiment of the present inventive concept may be applied to an electronic device having a display device. For example, the present inventive concept may be applied to a computer monitor, a laptop, a digital camera, a cellular phone, a smart phone, a smart pad, a television, a personal digital assistant (PDA), a portable multimedia player (PMP), a MP3 player, a navigation system, a game console, a video phone, etc.

The foregoing is illustrative of exemplary embodiments of the inventive concept and is not to be construed as limiting thereof. Although a few exemplary embodiments have been described, many modifications are possible in these exemplary embodiments without materially departing from the disclosure. Accordingly, all such modifications are intended to be included within the scope of the present inventive concept.

What is claimed is:

1. A display panel comprising:
a first scan line, a second scan line, a third scan line, and an emission control line disposed in one direction;
a data line and a repair data line disposed across the first through third scan lines;
an organic light emitting diode;
a display pixel circuit including a first node that is electrically coupled to an anode of the organic light emitting diode, wherein the display pixel circuit is coupled to the first through third scan lines of an (N)th row and the data line; and
a repair pixel circuit including a repair line that is extended in a direction of the first through third scan lines, wherein the repair pixel circuit is coupled to the first scan line of an (N−1)th row, the second and third scan lines of the (N)th row, and the repair data line, and
wherein N is an integer greater than or equal to 2.

2. The display panel of claim 1, wherein the anode of the organic light emitting diode is electrically disconnected from the first node of the display pixel circuit, and a second node is formed by electrically coupling the anode of the organic light emitting diode to the repair line by a repair process when a brightness defect occurs in the organic light emitting diode.

3. The display panel of claim 2, wherein the repair pixel circuit comprises:
a driving transistor configured to generate a driving current applied to the organic light emitting diode in response to a data signal applied through the data line;
a first switching transistor configured to initialize the second node to have an initialization voltage in response to a first scan signal applied through the first scan line;
a second switching transistor configured to initialize a gate electrode of the driving transistor to have the initialization voltage in response to a second scan signal applied through the second scan line;
a storage capacitor configured to store the data signal;
third and fourth switching transistors configured to form a path through which the data signal is stored in the storage capacitor by turning on in response to a third scan signal applied through the third scan line; and
fifth and sixth switching transistors configured to apply the driving current generated by the driving transistor to the second node in response to an emission control signal applied through the emission control line.

4. The display panel of claim 3, wherein a gate electrode of the first switching transistor is coupled to the first scan line of the (N−1)th row.

5. The display panel of claim 2, wherein the display pixel circuit comprises:
a driving transistor configured to generate a driving current applied to the organic light emitting diode in response to a data signal applied through the data line;
a first switching transistor configured to initialize the first node to have an initialization voltage in response to a first scan signal applied through the first scan line;
a second switching transistor configured to initialize a gate electrode of the driving transistor to have the initialization voltage in response to a second scan signal applied through the second scan line;
a storage capacitor configured to store the data signal;
third and fourth switching transistors configured to form a path through which the data signal is stored in the storage capacitor by turning on in response to a third scan signal applied through the third scan line; and
fifth and sixth switching transistors configured to apply the driving current generated by the driving transistor to the first node in response to an emission control signal applied through the emission control line.

6. The display panel of claim 5, wherein a gate electrode of the first switching transistor is coupled to the first scan line of the (N)th row.

7. The display panel of claim 1, wherein the repair data line and the repair pixel circuit are disposed in a non-display area of the display panel.

8. The display panel of claim 1, wherein the repair data line and the repair pixel circuit are disposed near one side of the display panel.

9. The display panel of claim 1, wherein the repair data line and the repair pixel circuit are disposed near one side of the display panel, and a second repair data line and second repair pixel circuit are disposed near another side of the display panel.

10. An organic light emitting display (OLED) device comprising:
a display panel including an organic light emitting diode, a display pixel circuit having a first node coupled to an anode of the organic light emitting diode, and a repair pixel circuit having a repair line;
a scan driving unit configured to provide a plurality of scan signals to the display panel through a plurality of scan lines;
a data driving unit configured to provide a plurality of data signals to the display panel through a plurality of data lines;
an emission control unit configured to provide a plurality of emission control signals to the display panel through a plurality of emission control lines; and
a timing control unit configured to control the scan driving unit, the data driving unit, and the emission control unit,
wherein the display pixel circuit is coupled to a first scan line of an (N)th row, and the repair pixel circuit is coupled to the first scan line of an (N−1)th row, and
wherein N is an integer greater than or equal to 2.

11. The OLED device of claim 10, wherein an anode of the organic light emitting diode is electrically disconnected from the first node of the display pixel circuit, and a second node is formed by electrically coupling the anode of the organic light emitting diode to the repair line by a repair process when a brightness defect occurs in the organic light emitting diode.

12. The OLED device of claim 11, wherein the scan signals comprises:
a first scan signal applied to the display panel through a first scan line disposed in one direction of the display panel;
a second scan signal applied to the display panel through a second scan line disposed in parallel to the first scan line; and
a third scan signal applied to the display panel through a third scan line disposed in parallel to the first scan line and the second scan line.

13. The OLED device of claim 12, wherein the repair pixel circuit comprises:
a driving transistor configured to generate a driving current applied to the organic light emitting diode in response to the data signal;
a first switching transistor configured to initialize the second node to have an initialization voltage in response to the first scan signal;
a second switching transistor configured to initialize a gate electrode of the driving transistor to have the initialization voltage in response to the second scan signal;
a storage capacitor configured to store the data signal;
third and fourth switching transistors configured to form a path through which the data signal is stored in the storage capacitor by turning on in response to the third scan signal; and
fifth and sixth switching transistors configured to apply the driving current generated by the driving transistor to the second node in response to the emission control signal.

14. The OLED device of claim 13, wherein a gate electrode of the first switching transistor is coupled to the first scan line of the (N−1)th row.

15. The OLED device of claim 12, wherein the display pixel circuit comprises:
a driving transistor configured to generate a driving current in response to the data signal;
a first switching transistor configured to initialize the first node to have an initialization voltage in response to the first scan signal;
a second switching transistor configured to initialize a gate electrode of the driving transistor to have the initialization voltage in response to the second scan signal;
a storage capacitor configured to store the data signal;
third and fourth switching transistors configure to form a path through which the data signal is stored in the storage capacitor by turning on in response to the third scan signal; and
fifth and sixth switching transistors configured to apply the driving current generated by the driving transistor to the first node in response to the emission control signal.

16. The OLED device of claim 15, wherein a gate electrode of the first switching transistor is coupled to the first scan line of the (N)th row.

17. The OLED device of claim 10, wherein the repair pixel circuit is disposed near one side of the display panel.

18. The OLED device of claim 10, wherein the repair pixel circuit is disposed near one side of the display panel and a second repair pixel circuit is disposed near another side of the display panel.

19. A display panel comprising:
N rows, wherein each row comprises a pixel including an organic light emitting diode and a display pixel circuit, a first scan line, a second scan line, a third scan line, an emission control line, and a repair pixel circuit including a repair line extending in a direction of the first through third scan lines; and
a data line and a repair data line disposed across the first through third scan lines,
wherein the display pixel circuit includes a first node that is electrically coupled to an anode of the organic light emitting diode and the display pixel circuit is coupled to the first through third scan lines of the (N)th row and the data line,
wherein the repair pixel circuit is coupled to the first scan line of the (N−1)th row, the second and third scan lines of the (N)th row, and the repair data line, and
where N is an integer greater than or equal to 2.

20. The display panel of claim 19, wherein the anode of the organic light emitting diode is electrically disconnected from the first node of the display pixel circuit, and a second node is formed by electrically coupling the anode of the organic light emitting diode to the repair line by a repair process when a brightness defect occurs in the organic light emitting diode.
